(19) United States
(12) Patent Application Publication
(10) Pub. No.: US 2010/0253806 A1
(43) Pub. Date: Oct. 7, 2010

(54) IMAGING SYSTEM AND IMAGING METHOD THEREOF

(75) Inventor: QI-DA GUAN, Foshan (CN)

Correspondence Address: Altis Law Group, Inc.;ATTN: Steven Reiss, 288 SOUTH MAYO AVENUE, CITY OF INDUSTRY, CA, 91789, US

(73) Assignees: PREMIER IMAGE TECHNOLOGY(CHINA) LTD., Foshan City (CN); HON HAI PRECISION INDUSTRY CO., LTD., Tu-Cheng (TW)

(21) Appl. No.: 12/540,347

(22) Filed: Aug. 12, 2009

(30) Foreign Application Priority Data
Apr. 7, 2009 (CN) 200910301376.5

(51) Int. Cl. H04N 5/76; G06K 9/46

(52) U.S. Cl. 348/231.3; 382/195; 348/E05.031

(57) ABSTRACT

An imaging system includes a memory, an identifying module, an image capturing module, and a processing module. The memory is configured for storing a reference portrait image. The identifying module is configured for identifying and storing a reference feature parameter of a sample portrait from the reference portrait image. The image capturing module is configured for capturing a video. The identifying module is further configured for identifying a feature parameter of the portrait in the captured video. The processing module is configured for changing the pixel values of each pixel in an area occupied by a portrait within the captured video to hide the portrait in the captured video when the feature parameter of the portrait in the captured video is the same as the reference feature parameter of the sample portrait.

### BACKGROUND

1. Technical Field

The present disclosure relates to imaging technologies and, particularly, to an imaging system and an imaging method thereof.

2. Description of the Related Art

Imaging systems are widely used in television broadcast field. In a television program of interview, a portrait of the interviewee in a video has to be hid for some private reasons. Generally, the portrait in the video is hid after a real-time video is captured. However, it is inconvenient when the television program of interview has to be broadcast.

Therefore, it is desirable to provide an imaging system and an imaging method thereof which can overcome or at least alleviate the above-mentioned problem.

### BRIEF DESCRIPTION OF THE DRAWINGS

FIG. 1 is a functional block diagram of an imaging system according to an exemplary embodiment.

FIG. 2 is a flowchart of an imaging method according to an exemplary embodiment.

### DETAILED DESCRIPTION

Embodiments of the disclosure will now be described in detail with reference to the accompanying drawings.

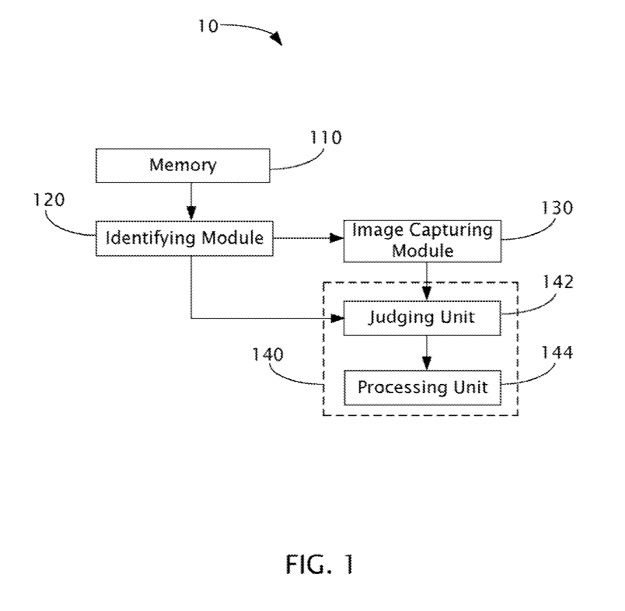

Referring to FIG. 1, an imaging system 10 according to an exemplary embodiment includes a memory 110, an identifying module 120, an image capturing module 130, and a processing module 140. In this embodiment, the imaging system 10 is a digital video camera to capture a live video to broadcast.

The memory 110 is configured for storing a predetermined reference portrait image. In this embodiment, the predetermined reference portrait image is obtained from an interviewee before the interview begins. It is to be understood that the reference portrait image may be captured by the imaging system 10 or transmitted from external devices before a live video is captured.

The identifying module 120 is configured for identifying a reference feature parameter T₁ of a sample portrait from the predetermined reference portrait image and storing the reference feature parameter T₁. The reference feature parameter T₁ of the sample portrait is invariable when the sample portrait is captured from different viewing angles. In this embodiment, the reference feature parameter T₁ may be selected from the group consisting of a first ratio of a horizontal width of the left eye to a horizontal width of the right eye in the portrait image, a second ratio of a distance between the center of the pupil of the left eye and the nose tip to a distance between the center of the pupil of the right eye and the nose tip, and a third ratio of a distance between the two corners of the mouth to a distance between the two centers of the two nostril. In this embodiment, the reference feature parameter T₁ is the third ratio.

The imaging module 130 is configured for capturing a video of a interviewee. The captured video contains consecutive images of the interviewee at a predetermined rate, e.g., 60 images per second. The imaging module 130 may include an image sensor, such as a charge-coupled device (CCD) or a complementary metal oxide semiconductor (CMOS) device.

The identifying module 120 is configured for identifying a feature parameter T₂ of the portrait in the video. In this embodiment, T₂=d3/d4, wherein d3 is a distance between the two corners of the mouth of the sample portrait, and d4 is the center of the two nostril of the sample portrait.

The processing module 140 includes a judging unit 142 and a processing unit 144. The judging unit 142 is configured for determining whether the feature parameter T₂ of the portrait in the captured video is the same as the reference feature parameter T₁ of the sample portrait. The processing unit 144 is configured for changing the pixel values of each pixel in an area occupied by the portrait within the captured video, when the feature parameter T₂ of the portrait in the captured video is the same as the reference feature parameter T₁ of the sample portrait, thereby hide the portrait in the captured video. In this embodiment, the processing unit 144 changes the pixel values of each pixel in the area occupied by the portraits within the captured video to 0, for blacking the area occupied by the portrait within the captured video. It is to be understood, in other embodiment, the processing unit 144 can also change the pixel values of each pixel in the area occupied by the portraits within the captured video to 1, for whitening the area occupied by the portraits within the captured video.

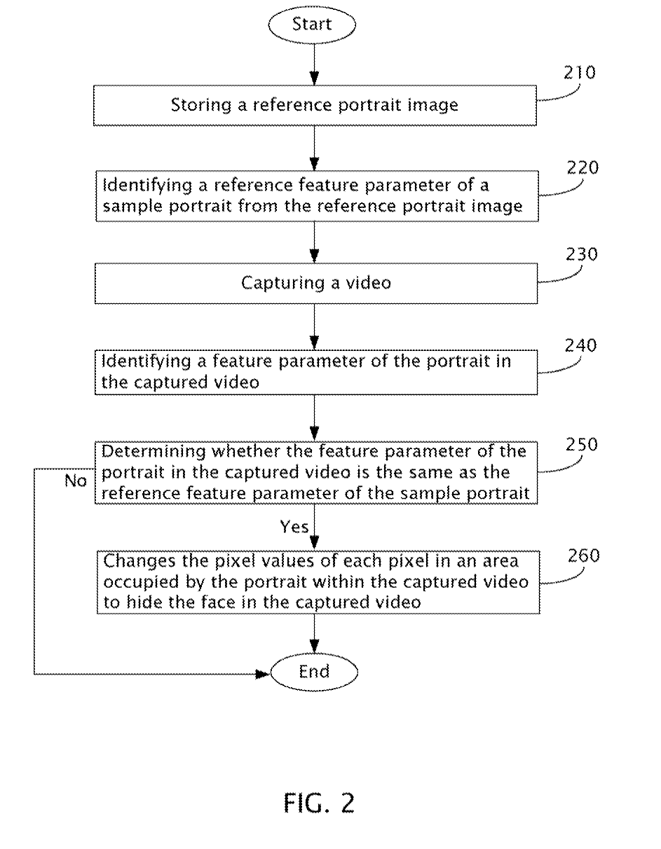

Referring to FIG. 2, an imaging method can be exemplarily implemented by the imaging system 10, according to the exemplary embodiment, and includes the following steps S210-S260.

In step 210, the reference portrait image is stored by the memory 110 before the interview begins.

In step 220, the reference feature parameter T₁ of the sample portrait is identified by the identifying module 120 from the reference portrait image and stored. In this embodiment, the reference feature parameter T₁ is the third ratio.

In step 230, a video of a interviewee is captured by the imaging module 130.

In step 240, a feature parameter T₂ of the portrait in the captured video is identified by the identifying module 120. In this embodiment, T₂=d₃/d₄, wherein d₃ is a distance between the two corners of the mouth of the sample portrait, and d₄ is a distance of the two centers of the two nostril of the sample portrait.

In step 250, the feature parameter T₂ of the portrait in the captured video is determined by the judging unit 142 whether the feature parameter T₂ is the same as the reference feature parameter T₁ of the sample portrait.

In step 260, the pixel values of each pixel in an area occupied by the portrait within the captured video is changed by the processing unit 144, when the feature parameter T₂ of the portrait in the captured video is the same as the reference feature parameter T₁, hide the portrait in the captured image. In this embodiment, the pixel values of each pixel in the area occupied by the portraits within the captured video are changed to 0 by the processing unit 144.

It is to be understood, when the number of the reference feature parameters T₁ of the sample is more, the number of feature parameters T₂ of the portrait in the captured video can be more and are compared to the reference feature parameters T₁ respectively.

It is to be understood, however, that even though numerous characteristics and advantages of the embodiments have been set forth in the foregoing description, together with details of the structures and functions of the embodiments, the disclosure is illustrative only, and changes may be made in details, especially in matters of arrangement of parts within the principles of the invention to the full extent indicated by the broad general meaning of the terms in which the appended claims are expressed.

What is claimed is:

1. An imaging system comprising:
a memory configured for storing a reference portrait image;
an identifying module configured for identifying and storing a reference feature parameter of at least one sample portrait from the reference portrait image;
an image capturing module configured for capturing a video;
the identifying module further configured for identifying a feature parameter of the portrait from the captured video; and
a processing module configured for changing the pixel value of each pixel in an area occupied by the portraits within the captured video to hide the portrait when the feature parameter of a portrait in the captured video is the same as the reference feature parameter of the sample portrait.

2. The imaging system of claim 1, wherein the reference feature parameter is selected from the group consisting of a first ratio of a horizontal width of the left eye to a horizontal width of the right eye of the portrait in the reference portrait image, a second ratio of a distance between the center of the pupil of the left eye and the center of the nose tip to a distance between the center of the pupil of the right eye and the center of the nose tip, and a third ratio of a distance between the two corners of the mouth to a distance between the two centers of the two nostril.

3. The imaging system of claim 2, wherein the processing module comprises a judging unit and a processing unit, the judging unit is configured for determining whether the feature parameter of the portrait in the captured video is the same as reference feature parameter of the sample portrait, the processing unit is configured for changing the pixel values of each pixel in an area occupied by the portraits within the video to hide the portrait in the captured video.

4. The imaging system of claim 2, wherein the processing unit is configured for changing the pixel values of each pixel in an area occupied by the portraits within the captured video to 0.

5. The imaging system of claim 2, wherein the processing unit is configured for changing the pixel values of each pixel in an area occupied by the portraits within the captured video to 1.

6. An imaging method comprising:
storing a reference portrait image;
identifying a reference feature parameter of a sample portrait from the reference portrait image;
capturing a video;
identifying a feature parameter of the portrait in the captured video;
changing the pixel values of each pixel in an area occupied by the portraits within the captured video to hide the portrait in the captured video when the feature parameter of a portrait in the captured video is the same as the reference feature parameter of the sample portrait.

7. The imaging method of claim 6, wherein the feature parameter comprises a first ratio of the horizontal width of the left eye to the horizontal width of the right eye of the portrait in the portrait image, a second ratio of the distance between the center of the pupil of the left eye to the center of the nose tip and the distance between the center of the pupil of the right eye and the center of the nose tip, and a third ratio of the distance between the two corners of the mouth to the distance between the two centers of the two nostril.

8. The imaging method of claim 6, wherein the step of processing comprises a step of changing the pixel values of each pixel in an area occupied by the portraits within the video to 0.

9. The imaging method of claim 6, wherein the step of processing comprises a step of changing the pixel values of each pixel in an area occupied by the portraits within the video to 1.
